(19) United States
(12) Patent Application Publication
(10) Pub. No.: US 2004/0195055 A1
(43) Pub. Date: Oct. 7, 2004

(54) Disc brake

(76) Inventor: Leo Gilles, Koblenz (DE)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/829,536

(22) Filed: Apr. 22, 2004

Related U.S. Application Data
(63) Continuation of application No. PCT/EP02/11847, filed on Oct. 23, 2002.

(30) Foreign Application Priority Data
Oct. 24, 2001 (DE) 101 52 422.6

(51) Int. Cl. F16D 55/16

(52) U.S. Cl. 188/73.1

(57) ABSTRACT

A disc brake (10) is described, having two brake shoes (12, 14), which for generating a clamping force (A, A′) are pressable against both sides of a brake disc (16), and an actuator device (26) for actuating at least one of the brake shoes (12, 14). The disc brake comprises a force transducer (42) e.g. in the form of a force sensor, which is disposed in a first force transmission path (C) between the actuator device (26) and at least one of the brake shoes (12, 14).

The invention relates to a disc brake having two brake shoes, which for generating a clamping force are pressable against both sides of a brake disc, and an actuator device for actuating at least one of the brake shoes.

Such a disc brake is known from WO88/04741. The forces arising in this disc brake during a braking operation may be subdivided into clamping force (also known as axial force, transverse force or normal force) and peripheral force (also known as frictional force). The component of force introduced by a brake shoe into the brake disc at right angles to the plane of the brake disc is described as a clamping force. By peripheral force, on the other hand, is meant the component of force, which on account of the brake friction between a friction lining of the brake shoe and the brake disc acts in peripheral direction of the brake disc upon the brake shoe. By multiplying the peripheral force by the distance of the application point of the peripheral force from the axis of rotation of the wheels, the braking torque may be determined.

In the disc brake known from WO88/04741, the clamping force is generated either hydraulically or by means of an electric motor. In the case of generation of the clamping force by means of a motor, the rotational motion of a motor shaft is first geared down by means of a planetary gear and then converted into a translational motion by means of an actuator device comprising a nut/spindle arrangement. A piston of the actuator device transmits the translational motion to one of the two brake shoes and presses it against the brake disc. As the disc brake is designed as a floating-caliper disc brake, in a known manner the brake shoe not interacting directly with the piston is also pressed against the brake disc.

Future brake systems, for open- and closed-loop control purposes, require an exact measurement of the forces arising during a braking operation. It is therefore customary to equip disc brakes with one or more force transducers and to couple these force transducers to open- and closed-loop control circuits. Any device, which converts a force acting upon the force transducer into a physical quantity different from said force, is capable of operating as a force transducer.

DE 196 39 686 A1 describes such a disc brake equipped with force transducers. The disc brake possesses two force transducers, which are disposed in each case on a fastening screw, by means of which a caliper is connected to a vehicle-fixed holder. The force transducers are used to measure the peripheral force, which is taken into account by a control device of a not specifically described electromechanical wheel brake actuator when setting the clamping force.

The underlying object of the invention is to indicate a disc brake, which is of an optimized construction with regard to open- and closed-loop control purposes.

Proceeding from a disc brake of the initially described type, this object is achieved according to the invention in that at least one force transducer, which may be part of a force measurement device, is disposed in a first force transmission path between the actuator device and at least one of the brake shoes. The force transducer, which may be disposed completely or at least in the form of one or more force transducer components between the actuator device and at least one of the brake shoes, allows at least some of the retroactive or reactive force, which is introduced into the actuator device upon generation of the clamping force, to be taken up, converted and/or measured.

Between the force transducer and the at least one brake shoe a force transmission device may be disposed, which interacts directly or indirectly with the force transducer upon application of the brake shoes against the brake disc. This interaction between force transmission device and force transducer occurs preferably in a two-dimensional manner. The force transducer is therefore advantageously designed in such a way that it allows the take-up of a force acting in a two-dimensional manner upon it.

Different options are available for realizing the force transducer. A common feature of all of the options is the functional aspect that a force acting upon the force transducer is converted into a quantity different from this force, e.g. an electrical or mechanical quantity. It is therefore conceivable, for example, to generate the relevant measuring signal in the form of e.g. a voltage change or resistance change by means of the force transducer directly at its installation location. In said case, the force transducer acts as a conventional force sensor. It is however also conceivable to convert the force acting upon the force transducer at the installation location of the force transducer initially into another physical measured quantity, e.g. pressure, and evaluate the resulting pressure signal at a location remote from the installation location of the force transducer or at the installation location of the force transducer. The evaluation of this other physical measured quantity may entail a further conversion.

According to a preferred form of construction, the force transducer takes the form of a force-to-resistance transducer, which from a force acting upon the force transducer generates an electrically or electronically evaluable resistance signal. This force-to-resistance conversion may be effected in one or more stages. In the case of a multi-stage conversion, the force-to-resistance transducer may in a first step by means of a force-to-pressure transducer convert the force signal into a pressure signal, which is then converted in a second step by means of a pressure-to-resistance transducer into an electrical resistance change. The pressure-to-resistance transducer is preferably manufactured by single-chip technology. If the force transducer effects a resistance conversion, the evaluation of the force signal is advantageously according to the principle of a Wheatstone bridge.

The force transducer may have a chamber, which is filled with a fluid medium and sealed by a diaphragm, which interacts with the force transmission device. Given such a development of the force transducer, the introduction of a preferably two-dimensional force into the diaphragm leads to an increase of the fluid pressure inside the chamber. A force-to-pressure conversion accordingly occurs. In a next step, the pressure increase may be measured to determine the force acting upon the diaphragm.

As already initially explained, the at least one force transducer is disposed in a first force transmission path between the actuator device and at least one of the brake shoes. Between the actuator device and at least one of the brake shoes a second force transmission path may be additionally provided, which bypasses the force sensor. The first force transmission path and the second force transmission path extend preferably at least in sections parallel to one another, so that the force transmitted along the first force transmission path is reduced.

The second force transmission path is advantageously activated only after a force threshold value has been exceeded in order in said manner to limit the maximum force acting upon the force transducer. Via the second force transmission path, which by-passes the force transducer, it is therefore possible to transmit at least the component of force that exceeds the force threshold value. Preferably, the force threshold value is less than half and ideally less than a quarter of the maximum force introducible into the actuator device.

The already described force transmission device may be disposed either in the first force transmission path or in the second force transmission path or, at least in sections, both in the first force transmission path and in the second force transmission path. According to a preferred development of the invention, the force transmission device is provided with control means e.g. in the form of a first stop, which allow the second force transmission path to be activated in a defined manner. If the force transmission device comprises e.g. a piston movable relative to the force transducer, then this first stop for activating the second force transmission path may be formed by a diameter enlargement of the piston. An activation of the second force transmission path may in said case be effected in that the diameter enlargement of the piston interacts with a second stop, which is coupled in force transmission direction rigidly to a component of the actuator device. The force transmission direction is the direction, in which upon actuation of the brake shoes the resultant reactive force is introduced into the actuator device.

In addition to the piston or instead of the piston, the force transmission device may comprise an elastic reaction element, which is movable relative to the force transducer. This elastic reaction element is preferably disposed in the first force transmission path between the piston and the force transducer. The reaction element on account of its elastic properties enables direct, damage-free interaction with the force transducer, preferably with an elastic diaphragm of the force transducer.

The actuator device may be provided with a receiver for the force transducer. This receiver is preferably disposed in a central region of the actuator device in order to enable a uniform introduction of force into the force transducer. The receiver may be formed integrally with a further component of the actuator device or form a separate component of the actuator device.

The actuator device may possess a guide for the force transmission device. It is possible for the receiver for the force transducer, which receiver is part of the actuator device, to be provided with such a guide. Advantageously, the receiver in said case has a substantially hollow-cylindrical shape, wherein a part of the hollow-cylindrical receiver facing the brake shoes acts as a guide for the force transmission device and the force transducer is disposed in a base of the hollow-cylindrical receiver remote from the brake shoes.

If the force transmission device comprises the elastic reaction element described above, the guide may be provided with at least one recess, into which the reaction element may yield in the event of its elastic deformation. By virtue of providing one or more of such recesses, damage to the force transducer as a result of the introduction of excessively high forces into the reaction element is avoided.

As far as the development of the actuator device is concerned, different concepts are available. The actuator device may be motor-actuable or hydraulically actuable. It is moreover possible for one and the same actuator device to be developed so as to be both hydraulically actuable and motor-actuable. Given such a development of the actuator device, a parking brake function may be realized by means of the motor actuation. According to a preferred development of the invention, the disc brake is part of an electromechanical brake system.

Advantageously, the actuator device of the disc brake has an at least translationally movable actuator element, which depending on the development of the actuator device may additionally be settable in rotation. Such an actuator element may be coupled in a force transmission direction rigidly to the receiver for the force sensor. It is therefore conceivable for the receiver to be formed integrally with the translationally movable actuator element or to be fastened by means of a mounting for the receiver to the translationally movable actuator element.

According to a preferred development of the invention, the translationally movable actuator element has a hollow space, into which the receiver extends at least in sections. If the translationally movable actuator element is designed e.g. as a hollow-cylindrical piston, then the receiver may extend into the hollow-cylindrical region of the piston and be fastened e.g. by means of a mounting to the piston.

If the actuator device comprises a nut/spindle arrangement, the translationally movable actuator element may be formed either by the nut or by the spindle of the nut/spindle arrangement. The translationally movable actuator element may however alternatively be a separate component, which is coupled preferably rigidly to the nut or the spindle of the nut/spindle arrangement.

The invention has a great many possible areas of application. The advantages according to the invention are particularly pronounced in an electromotive vehicle brake system equipped with the disc brake according to the invention. An embodiment of a disc brake according to the invention is described in detail below with reference to the accompanying diagrammatic drawings. The drawings show:

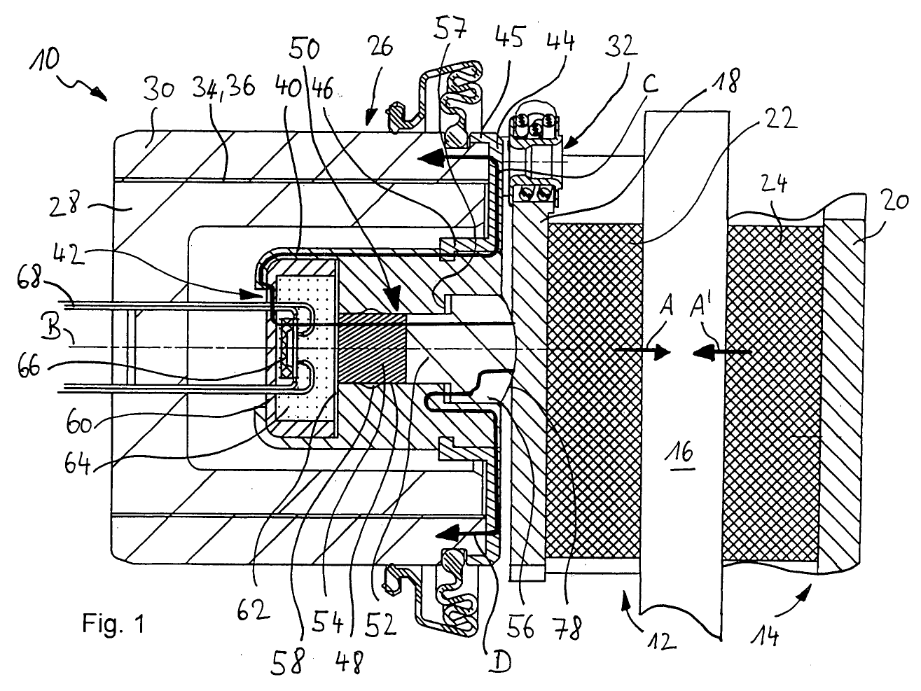

FIG. 1 a sectional view of part of a first embodiment of a disc brake according to the invention;

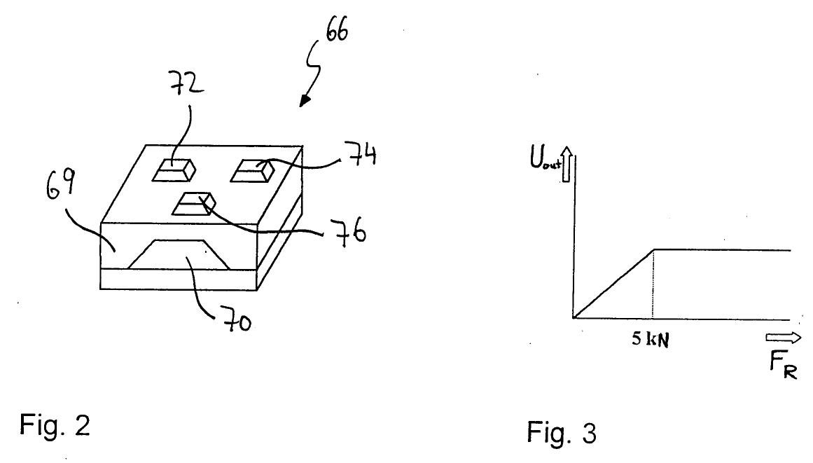

FIG. 2 part of a force transducer of the disc brake according to FIG. 1;

FIG. 3 a representation of the dependence of an output signal of the force transducer as a function of the reactive force acting upon an actuator device of the disc brake according to FIG. 1; and

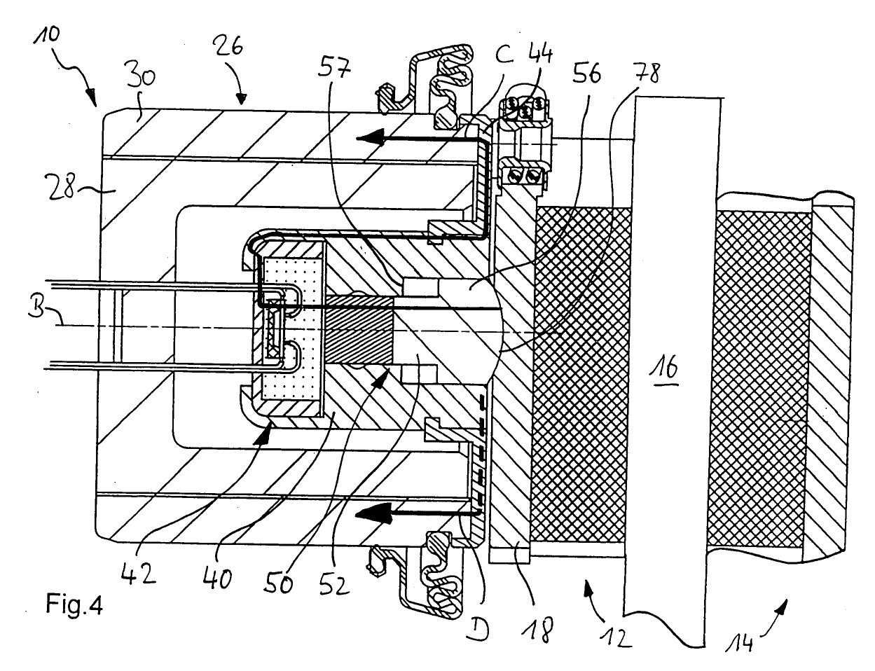

FIG. 4 a sectional view according to FIG. 1 of part of a second embodiment of a disc brake according to the invention.

In FIG. 1 several components of a floating-caliper disc brake 10 according to the invention in accordance with a first embodiment of the invention are illustrated. The disc brake 10 comprises two brake shoes 12, 14, which are pressable against both sides of a brake disc 16. Each of the two brake shoes 12, 14 has a carrier plate 18, 20 and a friction lining 22, 24 disposed on the carrier plate 18, 20. By means of the respective friction lining 22, 24 the two brake shoes 12, 14 interact with the brake disc 16. During the interaction of the brake shoes 12, 14 with the brake disc 16 a clamping force is generated, which acts in the direction of the arrows A, A′.

For generating the clamping force an electric motor is provided, which is not shown in FIG. 1 and in a known manner interacts with a step-down gear, which is likewise not shown in FIG. 1. An output side of the step-down gear is connected to an actuator device 26. The actuator device 26 converts a rotational motion of the electric motor into a translational motion for the translatory actuation of the brake shoes 12, 14.

In the embodiment according to FIG. 1 the actuator device 26 is a nut/spindle arrangement, which comprises a rotationally movable, cup-shaped spindle 28 as well as a hollow-cylindrical nut 30, which is disposed coaxially with and radially outside of the spindle 28. The brake shoe 12 is coupled by means of a coupling device 32, which is familiar to the person skilled in the art, in such a way to the actuator device 26 that the brake shoe 12 is displaceable in a guided manner in the direction of the arrow A relative to the actuator device 26.

The actuator device 26 is designed in such a way that a rotational motion of the spindle 28 about a longitudinal axis B of the actuator device 26 is converted into a translational motion of the nut 30 along said longitudinal axis B. For this purpose, the cup-shaped spindle 28 is provided with an external thread 34, which interacts with a complementary internal thread 36 of the nut 30. The nut 30 is mounted likewise in a rotationally fixed manner inside a housing of the disc brake 10 that is not shown in FIG. 1.

The spindle 28 may be coupled in various ways, e.g. by means of a bottom tooth system, to the step-down gear, which is not shown in FIG. 1. In the case of a curved-tooth system, there is not just a rotationally fixed connection between spindle 28 and step-down gear but the spindle 28 is movable within a specific angular range about the longitudinal axis B. Transverse forces arising during the rotational motion of the spindle 28 may be reliably compensated in said manner.

Disposed coaxially with the spindle 28 and nut 40 and radially at the inside of the spindle 28 and nut 40 is a receiver 40 for a force transducer 42. The receiver 40 is fastened by means of an annular mounting 44 to the nut 30. A radially outer end 45 of the mounting 44 embraces an end of the nut 30 facing the brake shoes 12, 14. A radially inner, flange-like region 46 of the mounting 44 is fastened to the receiver 40.

The receiver 40 has a substantially hollow-cylindrical shape, wherein a hollow-cylindrical portion of the receiver 40 facing the brake shoes 12, 14 acts as a guide 48 for a force transmission device 50. The force transmission device 50 comprises a piston 52 and an elastic, cylindrical reaction element 54 made of rubber. In a region facing the brake shoes 12, 14 the piston 52 has an outside diameter enlargement 56, for which in the receiver 40 a stop in the form of an inside diameter reduction 57 is provided. The hollow-cylindrical receiver 40 moreover has, radially at the inside in the region of the reaction element 54, a groove 58 extending in peripheral direction and used to receive the reaction element 54 in the event of its elastic deformation.

The force transducer 42 is held in the hollow-cylindrical receiver 40 in a rear region remote from the brake shoes 12, 14. The force transducer 42 comprises a pot-shaped element 60, which at its sides facing the brake shoes 12, 14 is sealed by an elastic diaphragm 62. The pot-shaped element 60 and the diaphragm 62 together define a chamber 64, which is filled with oil or some other fluid medium. Disposed inside the chamber 64 is a pressure-to-resistance transducer 66, which is electrically contacted by a plurality of electric feeders 68. The electric feeders 68 extend both through the base of the pot-shaped element 60 and through the base of the cup-shaped spindle 28 and lead to a closed-loop control circuit, which is not shown in FIG. 1.

The pressure-to-resistance transducer 66 according to FIG. 1 is shown to an enlarged scale in FIG. 2. The pressure-to-resistance transducer 66 manufactured by single-chip technology comprises a ceramic housing 69, which surrounds a vacuum chamber 70, as well as a plurality of resistance elements 72, 74, 76. The pressure-to-resistance transducer 66 is part of a Wheatstone bridge, so that determination of the pressure may be effected by way of a resistance measurement. In accordance with the single-chip aspect, the pressure-to-resistance transducer 66 is disposed on a substrate, which is not shown in FIG. 2 and on which moreover components of a circuit for evaluating resistance changes of the resistance elements 72, 74, 76 are situated. This circuit generates a pressure-dependent output voltage Uₒᵤₜ.

There now follows a detailed description of the mode of operation of the disc brake 10 illustrated in FIG. 1 as well as of the determination by means of the force transducer 42 of the reactive force arising upon actuation of the brake shoes 12, 14.

If, starting from the inoperative position of the disc brake 10 illustrated in FIG. 1, the electric motor not shown in FIG. 1 is set in operation in order to generate a clamping force, the step-down thread likewise not shown in FIG. 1 transmits a rotational motion of the electric motor to the spindle 28 of the actuator device 26. For generation of a clamping force, the direction of rotation of the spindle 28 is selected in such a way that the nut 30 interacting with the spindle 28 is moved in FIG. 1 to the right.

The hollow-cylindrical receiver 40 coupled by means of the mounting 44 rigidly to the nut 30, the force transducer 42 fastened in the base of the hollow-cylindrical receiver 40, as well as the force transmission device 50 contacting the diaphragm 62 of the force transducer 42 are also taken up by this translational motion of the nut 30. The reaction element 54 of the force transmission device 50 is in abutment both against the diaphragm 62 and against the piston 52. The piston 52 in turn projects with its convex end face 78 remote from the force transducer 42 beyond the actuator device 26 and is in contact with a correspondingly shaped indentation in the rear side of the carrier plate 18 remote from the friction lining 22.

The brake shoe 12 is therefore taken up by the translational motion of the piston 52 and pressed in the direction of the arrow A against the brake disc 16. Owing to the disc brake 10 being structurally designed as a floating-caliper disc brake, as a reaction to the pressing of the brake shoe 12 against the brake disc 16 the opposite brake shoe 14 is also pressed in the direction of the arrow A′ against the brake disc 20. In said manner, a clamping force acting in the direction of the arrows A, A′ is generated.

In accordance with the physical principle actio=reactio, the generation of the clamping force results in the retroaction of a reactive force along a first force transmission path C from the brake shoe 12 to the actuator device 26. The first force transmission path C comprises the force transmission device 50 in the form of the piston 52 and the reaction element 54, the force transducer 42, its receiver 40, the mounting for the receiver 40, as well as the nut 30. The reactive force transmitted by the piston 52 to the reaction element 54 is transmitted by the reaction element 54, which interacts two-dimensionally with the diaphragm 62 of the force transducer 42, to the force transducer 42. The diaphragm 62 is therefore displaced in FIG. 1 to the left, as is the force transmission device 52. As the pot-shaped housing 60 of the force transducer 42 is firmly anchored in the receiver 40, the housing 60 is unable to follow this displacement of the diaphragm 62. The pressure inside the chamber 64 of the force transducer 42 consequently increases. A force-to-pressure conversion therefore occurs. The pressure increase inside the chamber 64 is converted by the pressure-to-resistance transducer 66 disposed in the chamber 64 into a resistance change. The resistance variation in turn allows a conclusion to be drawn about the reactive force transmitted along the first force transmission path C and is evaluated by a closed-loop control circuit, which is connected by means of the electric feeders 68 to the pressure-to-resistance transducer 66, and used for closed-loop control purposes.

In the inoperative position of the disc brake 10 illustrated in FIG. 1 there is a specific axial play between the diameter enlargement 56 of the piston 52 and the stop, provided for the diameter enlargement 56, in the form of the inside diameter reduction 57 of the receiver 40 for the force transducer 42. So long as this play is not used up, a translatory motion of the nut 30 in FIG. 1 to the right gives rise to a displacement of the piston 52 relative to the receiver 40 in FIG. 1 to the left, which displacement is induced by the retroactive force transmitted along the force transmission path C.

As already explained, the reaction element 54 and the diaphragm 62 are also taken up by this leftward displacement of the piston 52. As a result of the leftward displacement of the piston 52 relative to the receiver 40, the play between the diameter enlargement 56 and the stop in the form of inside diameter reduction 57 formed on the receiver 40 is gradually used up. At the same time, the reaction element 54 elastically deforms into the groove 58 formed in the region of the guide 48 for the force transmission device 52 since the oil disposed in the chamber 64 sets up an increasing resistance to a displacement of the diaphragm 62 in FIG. 1 to the left. The elastic deformation of the reaction element 54 into the groove 58 hampers further displacement of the reaction element 54 in FIG. 1 to the left. This prevents an excessively high retroactive force from acting upon the diaphragm 62 and damaging it.

As mentioned, an increase of the retroactive force leads to a leftward displacement of the piston 52 relative to the receiver 40. Once the play between the diameter enlargement 56 of the piston 52 and the inside diameter reduction 57 of the receiver 40 that is designed as a stop is used up, the piston 52 is supported by its diameter enlargement 56 against the receiver 40, with the result that a second force transmission path D is activated. The second force transmission path D extends in sections parallel to the first force transmission path C and bypasses the force transducer 42. The second force transmission path D comprises the piston 52, the receiver 40 for the force transducer 42, the mounting 44 for the receiver 40, as well as the nut 30.

As soon as the diameter enlargement 56 of the piston 52 at a specific threshold value of the retroactive force comes into abutment against the stop in the form of the inside diameter reduction 57 of the receiver 40, the component of retroactive force exceeding the threshold value is transmitted along the second force transmission path D. The component of retroactive force acting upon the force transducer 42, on the other hand, remains constant. More precisely, upon a further increase of the retroactive force the component of retroactive force transmitted along the first force transmission path C corresponds exactly to the threshold value, which is required in order to bring the diameter enlargement 56 of the piston 52 into abutment against the inside diameter reduction 57 of the receiver 40 that is designed as a stop.

The “cutting-in” of the second force transmission path D after a threshold value of the retroactive force has been exceeded manifests itself also in the output signal of the pressure-to-resistance transducer 66. This fact is illustrated in FIG. 3. FIG. 3 shows the dependence of an output voltage Uₒᵤₜ of the pressure-to-resistance transducer 66 as a function of the reactive force F_{R} introduced into the nut 30.

As FIG. 3 reveals, the output voltage Uₒᵤₜ initially rises linearly with increasing retroactive force F_{R}. This corresponds to the situation where the retroactive force F_{R} is transmitted exclusively via the first force transmission path C. At a threshold value of F_{R}=5 kN the diameter enlargement 56 of the piston 52 finally comes into abutment against the inside diameter reduction 57 of the receiver 40. This corresponds to an activation of the second force transmission path D, which bypasses the force transducer 42. The component of retroactive force F_{R} exceeding the threshold value of 5 kN is introduced in full along the second force transmission path D into the nut 30. Although the retroactive force F_{R} therefore continues to rise, the component of retroactive force transmitted along the first force transmission path C remains constant. As FIG. 3 reveals, for this reason the output voltage of the pressure-to-resistance transducer 66 above the threshold value of 5 kN is also constant. Damage to the force transducer 42 owing to a retroactive force exceeding the threshold value is therefore avoided.

In practice, it has emerged that a measurement range in the order of magnitude of 2-5 kN is adequate for the required control purposes. For measuring retroactive forces above 5 kN, other methods may be used. It is therefore conceivable, for example, to derive higher retroactive forces from the angle of rotation of the armature of an electric motor used to actuate the actuator unit 26.

In the course of the discussion thus far, the generation of the clamping force and the determination of the generated clamping force from the ensuing reactive force have been described. In order to discontinue or reduce the clamping force, the electric motor for actuating the actuator unit 26 is controlled in such a way that the spindle 28 changes its direction of rotation. As a result of the reversal of the direction of rotation, the nut 30 is moved in FIG. 1 to the left, thereby reducing the clamping force generated by the brake shoes 12, 14.

In FIG. 4 several components of a floating-caliper disc brake 10 according to the invention in accordance with a second embodiment of the invention are illustrated. The disc brake 10 according to the second embodiment corresponds in construction and function substantially to the floating-caliper disc brake according to the first embodiment described with reference to FIG. 1. For this reason, the following detailed description pertains only to the constructional and functional differences between the disc brake 10 according to the second embodiment, which is illustrated in FIG. 4, and the disc brake according to the first embodiment, which is illustrated in FIG. 1.

The fundamental difference between the disc brake 10 according to FIG. 4 and the disc brake according to FIG. 1 is that the axial play between the inside diameter reduction 57 of the receiver 40 and the end of the diameter enlargement 56 of the piston 52 facing this inside diameter reduction 57 is greater than the amount, by which the end face 78 of the piston 52 projects beyond the actuator device 26. This means that the inside diameter reduction 57 is no longer able to act as a stop for the diameter enlargement 56 of the piston 52. A limitation of the maximum force acting upon the force transducer 42 along the first force transmission path C is effected in the disc brake 10 according to FIG. 4 in that the carrier plate 18 of the brake shoe 12 with its end facing the actuator device 26 interacts in a two-dimensional manner with the ends of annular mounting 44 and receiver 40 facing the carrier plate 18. Such a two-dimensional interaction between the carrier plate 18, on the one hand, and the mounting 44 and the receiver 40, on the other hand, occurs as soon as the piston 52 has been displaced far enough in FIG. 4 to the left in the direction of the force transducer 42 for the amount, by which the end face 78 of the piston 52 projects beyond the ends of receiver 40 and mounting 44 facing the carrier plate 18, to be completely used up.

One advantage of the two-dimensional interaction between the carrier plate 18 and the actuator device 26, more precisely the mounting 44 and the receiver 40 of the actuator device 26, is the fact that a tilting of the brake shoe 12 relative to the actuator device 26 is prevented and the introduction of force from the brake shoe 12 into the actuator device 26 is improved. Clearly visible in FIG. 4 is the second force transmission path D, which is activated after a predetermined force threshold value has been exceeded. In the region of the dashes of the force transmission path D, the advantageous, two-dimensional force transmission between carrier plate 18 and actuator device 26 is effected, with simultaneous bypassing of the piston 52 and hence of the force transmission device 50. As FIG. 4 reveals, the force transmission arrangement 50 and, in particular, its piston 52 is therefore no longer a component part of the second force transmission path D. This measure ensures that excessively high reactive forces do not cause any damage to the force transmission arrangement 50.

Although the invention has been described by way of the two embodiments in connection with a motor-actuable disc brake, the arrangement according to the invention of the force transducer 42 relative to the actuator device 26 and the brake shoes 12, 14 may be used also in disc brakes having a hydraulically actuable actuator device. The preferred area of application of the invention is however in electromechanical brakes, which comprise force transducers for open- or closed-loop control purposes. The invention may also be used in disc brakes to realize a parking brake function capable of open- or closed-loop control.

1. A disc brake, comprising a brake disc having two opposite sides;
two brake shoes, which for generating a clamping force are pressable against both sides of the brake disc;
an actuator device for actuating at least one of the brake shoes; and
at least one force transducer disposed in a first force transmission path between the actuator device and at least one of the brake shoes, wherein a maximum component of force acting upon the force transducer upon generating of the clamping force is limited.

2. The disc brake according to claim 1, wherein a force transmission device is disposed between the at least one force transducer and the at least one brake shoe.

3. The disc brake according to claim 2, wherein the force transmission device interacts via a two-dimensional section with the at least one force transducer.

4. The disc brake according to claim 1, wherein the at least one force transducer is designed as a force-to-resistance transducer.

5. The disc brake according to claim 1, wherein the at least one force transducer comprises a force-to-pressure transducer and a pressure-to-resistance transducer disposed functionally downstream of the force-to-pressure transducer.

6. The disc brake according to claim 5, wherein the pressure-to-resistance transducer is manufactured by single-chip technology.

7. The disc brake according to claim 2, wherein the at least one force transducer has a chamber, which is filled with a fluid and sealed by a diaphragm, which interacts with the force transmission device.

8. The disc brake according to claim 2, wherein between the actuator device and at least one of the brake shoes a second force transmission path is provided, which bypasses the at least one force transducer.

9. The disc brake according to claim 8, wherein the second force transmission path is activated when a force threshold value is exceeded.

10. The disc brake according to claim 9, wherein at least the forces exceeding the force threshold value are transmissible via the second force transmission path.

11. The disc brake according to claim 8, wherein the force transmission device is disposed at least in sections both in the first force transmission path and in the second force transmission path.

12. The disc brake according to claim 8, wherein the force transmission device has control elements for activating the second force transmission path.

13. The disc brake according to claim 12, wherein the control elements for activating the second force transmission path are formed by a first stop of the force transmission device, which first stop interacts with a second stop, which is coupled in a force transmission direction rigidly to a component of the actuator device.

14. The disc brake according to claim 2, wherein the force transmission device comprises a piston movable relative to the at least one force transducer.

15. The disc brake according to claim 2, wherein the force transmission device comprises an elastic reaction element movable relative to the at least one force transducer.

16. The disc brake according to claim 15, wherein the reaction element is disposed in the first force transmission path between a moveable piston and the at least one force transducer.

17. The disc brake according to claim 2, wherein the actuator device has a receiver for the at least one force transducer.

18. The disc brake according to claim 17, wherein the receiver for the at least one force transducer has a guide for the force transmission device.

19. The disc brake according to claim 18, wherein the guide for the force transmission device has at least one recess for receiving in sections an elastic reaction element in the event of its elastic deformation.

20. The disc brake according to claim 17, wherein the actuator device comprises an at least translationally movable actuator element, which is coupled in a force transmission direction rigidly to the receiver.

21. The disc brake according to claim 20, wherein the translationally movable actuator element has a hollow space, into which the receiver extends at least in sections.

22. The disc brake according to claim 1, wherein the actuator device comprises a nut/spindle arrangement.

23. The disc brake according to claim 22, wherein a translationally movable actuator element is a component of the nut/spindle arrangement or is coupled rigidly to a component of the nut/spindle arrangement.

24. The disc brake according to claim 1, wherein the actuator device converts a driving motion of a motor into an actuating motion for actuating at least one of the brake shoes.

25. The disc brake according to claim 1, wherein the actuator device is hydraulically actuable.

26. A disc brake comprising
a brake disc;
two brake shoes pressable against the brake disc for generating a clamping force;
an actuator for actuating at least one of the brake shoes;
a force transducer arranged between the actuator and at least one of the brake shoes; and
a force limiting assembly for limiting the force acting upon the force transducer upon generation of the clamping force.

27. A disc brake comprising
a brake disc;
two brake shoes pressable against the brake disc for generating a clamping force;
an actuator for actuating at least one of the brake shoes;
a first force transmission path arranged between the actuator and at least one of the brake shoes;
a force sensing element disposed in the first force transmission path; and
a second force transmission path arranged between the actuator and at least one of the brake shoes, the second force transmission path bypassing the force sensing element.

28. The disc brake of claim 27,
further comprising an activating assembly for activating the second force transmission path when a predefined force threshold value is exceeded.
